(19) United States
(12) Patent Application Publication
(10) Pub. No.: US 2019/0076317 A1
(43) Pub. Date: Mar. 14, 2019

(54) High grade aluminum alloy tuning fork anodized with a pointed stem

(71) Applicant: Patricia Schloe, Phoenix, AZ (US)

(72) Inventor: Patricia Schloe, Phoenix, AZ (US)

(73) Assignee: Patricia Schloe, Phoenix, AZ (US)

(21) Appl. No.: 15/732,034

(22) Filed: Sep. 8, 2017

(51) Int. Cl. A61H 23/00; B22C 9/22

(52) U.S. Cl. CPC A61H 23/004; B22C 9/22

(57) ABSTRACT

High Grade Aluminum Alloy Tuning Fork—Anodized with a Pointed Stem that gives precise directional type treatment on clients is disclosed. Each Tuning fork is precisely and uniformly made by a CNC and Turning machine to maintain consistency. This is operated by a medical equipment and aerospace designer & machinist. The stem and tines are created separately and fused together during production. The weights are also custom made making the entire product a smooth surface that is color coded and anodized to each Tuning Fork in the set. Each fork in this production is then calibrated to a specific frequency within 0.1 to 0.5 Hz.

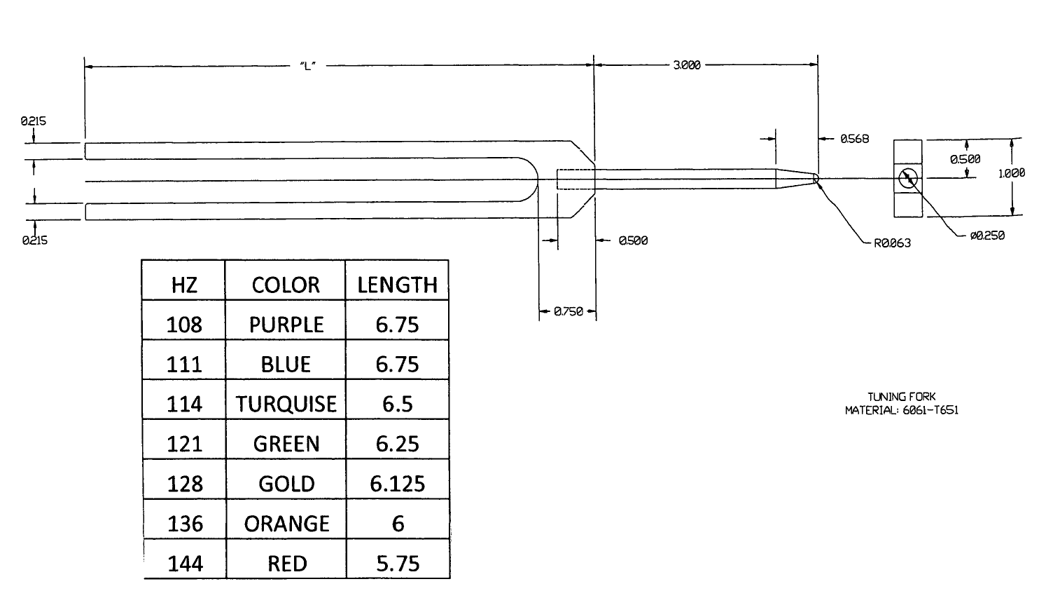

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND

The present invention relates to a medicinal tuning fork with a pointed stem where a non-needle like application is made to use vibrations and sound to travel into the body and relax the tissues. This fork is made up of a high grade Aluminum alloy with varied frequencies employing the pointed stem. The tuning forks better prepare the body for hands on massage or simply by using the forks alone and gives the clients improved and longer lasting results of relaxation and smooth muscles. The weights are custom made making the entire product a smooth surface that is color coded and anodized to each fork in the set. These forks are tuned to a specific frequency within 0.1-0.5 Hz. These devices are given the name of “TUNI”.

Tuning Forks with a pointed stem deliver sound and vibration with a point to the precise area of discomfort of the muscles. These devices are used on specific points on the body to relax and smooth muscle tissue. Bodies respond to sound as well as vibration—even more so with a precise directional approach in a ⅛th inch pointed stem device. It is a non-needle like instrument or probe that does not penetrate the skin. “Standard” tuning forks are made by falling within the guidelines and are left to the discretion of the factory worker to make it close enough to the guidelines. Standard tuning forks are each cut differently and the vibration and sound varies. Stems are a standard ¼ inch in diameter. Each fork is tuned within 0.5 Hz. Some of the patents are detailed below.

The Chinese Patent CN 202128468U discloses a frequency adjustable tuning fork which belongs to auxiliary medical appliances which is composed of fork strands and a fork handle the two fork strands are arranged at the top end of the fork handle; the frequency adjustable tuning fork is characterized in the two fork strands are fixedly provided with fork conversion parts through regulating nuts; the frequency conversion parts are cylindrical and are sleeved on the fork strands along the axial direction. Due to the frequency adjustable tuning fork and the working difficulty of doctors are reduced, and the working efficiency of doctors is improved. Another Patent US20110004130 is for preventing skin sag and wrinkle device consisting of two main components, namely, fork and pyramid-shaped stone, which are connected by means of cold soldered together permanently. The device is configured to be inserted into the apex of the pyramid the free end of the internal bore of the tuning fork base. Tuning fork may have two, three or four arms. For professional use, it may have a cylinder at the end of each arm. The two main parts are joined together by means of a hollow intermediate member can perform, at one end of the intermediate portion is inserted into the interior of the tuning fork, at the other end is connected to the pyramid. However, the present invention provides an advanced system with a high grade pointed stem aluminum alloy fork.

Medicinal tuning forks are permanently associated with names such as Weber and Rinne or Rydel Seiffer. The graduated tuning fork developed by Rydel Seiffer c 128 Hz/C 64 Hz is a standard in the field of neurology and is also probably the most well-known neurological tuning fork. This calibrated tuning fork has removable dampers with a ⅛ scale graduation and is used to identify a loss of the sense of vibrations, and is used to diagnose polyneuritis which can occur e.g. along with diabetes mellitus. With the screwed-on dampers, the fork vibrates at 64 Hz. Reference marks for exact calibration of the original KaWe tuning fork can be found on the back side of the fork tines. It is in this configuration that the tuning fork is used in vibration examinations. The screwed-on plastic foot allows for a gentle transfer of the vibrations from the tuning fork to the patient. Without the dampers, the instrument vibrates at a frequency of 128 Hz and is used for simple hearing and bone conductivity tests. This tuning fork method for testing aesthesia, which was first used in 1903 to test, is still considered the most dependable and safe even today.

Each tuning fork is slightly different when it is made by hand which changes the results when used by the practitioner. Some tuning forks are more difficult to use by the practitioner due to these changes. These changes are approved by the “standards to manufacture” regardless of the discrepancies noted. The differences can include the quality of the material, weights, tuning and design. The Present invention discloses multiple frequency calibrations and also clear instructions on how to use them so that they are more accurate to produce results.

Tuning forks with a pointed stem are precisely and uniformly made by a CNC and Turning machine. This is operated by a medical equipment and aerospace designer & machinist. The stem and tines are created separately and fused together during production. The present invention takes a standard tuning fork with a ¼ inch diameter stem and improves with a precise directional approach like a probe with a ⅛ inch stem and uses a higher grade Aluminum alloy to give a smooth finish with anodization to protect the surface. This makes it easier to clean the device between clients and the finish stays on when cleaned with alcohol or other cleaning product. There are various devices for tuning the frequency of the forks that brings devices within industry standard of within 0.5 Hz. The finish can be changed that would still give the product a finish that can be cleaned and maintained. A new device can be created and used to improve the tuning process during the last stage of production.

The present invention is an improvement in the sense that it presents advanced features in the sense that it provides for high grade Aluminum alloy and makes a mold to create weights, pointed stems and tines portion of the tuning forks. It uses varied frequencies to better sensor the nerves and relax the tissues and to be used in various modalities. It also has anodization on the surface so that it is easy to clean and remains hygienic to be used for medical purposes. It is tuned with 0.1-0.5% for more accurate results. Hence, the invention is commercially and personally an advantage over what already existed.

The limitation and non-effectiveness of the prior art has been overcome by the instant invention as described below.

### BRIEF SUMMARY OF THE INVENTION

The foregoing descriptions outline some pertinent features and objects of the present invention. These may be illustrative of more exhaustive and comprehensive features described later in the application. The technical terms used in this documents, are meant with the same meaning as understood by a typical expert of the field which is related to the invention.

The present invention pertinently describes a tuning fork with a pointed stem which offers a more precise directional treatment with ⅛^{th} inch pointed device and ¼^{th} inch diameter stem to area of discord to send the signals to brain, body and relax the tissues. This set is made with the following frequencies of 108.0 Hz, 111.0 Hz, 114.42 Hz, 121.23 Hz, 128.43 Hz, 136.07 Hz, 144.16 Hz, 80.91 Hz, 42.86 Hz. These frequencies are used on Minor Chakra Centre, Applied Kinesiology, Ayurveda and Nadi points with written permission given to Soundwaves 432 by Alice Bailey in Esoteric Healing and The Lucis Trust; Healing with the Chakra Energy System, by John R. Cross; Applied Kinesiology points by Dr. David Leaf. Alternate custom sets can be made with various frequencies employing the pointed stem, anodization and custom weights.

In a preferred embodiment, the system uses a higher grade aluminum alloy to give a smooth finish with anodization to protect the surface. This makes it easier to clean the device between clients and the finish stays on when cleaned with alcohol or other cleaning product.

In another aspect of the invention, it is created with a CNC & Turning machine and when completed; anodize the surface and last tuned to the correct frequency within 0.1-0.5 Hz. The weights are custom made making the entire product a smooth surface that is color coded and anodized to each fork in the set.

It is an objective of the present disclosed invention to provide the best system with technological advance above the traditional tuning forks. This product needs the expertise of someone who understands how a tuning fork operates and how to use it which influences the tuning and design. This product also requires the expertise of someone in the manufacturing of a medical/aerospace equipment to determine how to make a mold, use the proper equipment such as a CNC & turning machine, to complete the process using the various tools of manufacturing metals to create a uniform finished product from a specific design that is unique to this device. Currently—there is no device other than this one that provides a directional approach to treat with a pointed stem. A pointed stem provides a new innovative approach with a superior grade material that provides a color coded set with an anodized finish. Each Tuning fork can be made to a specific frequency using the calibration of Hertz depending on the size of the tines. Due to the versatility of the device to create in different frequencies and the different applications to the body—it can be used in a multitude of modalities or with listening to each tuning fork in a pattern.

These and other features, objects and advantages of the present invention will be readily visible to the persons ordinarily skilled in the art related to this field comprehending in entirety the above characteristics following descriptions and claims of the present invention.

### BRIEF DESCRIPTION OF THE DRAWINGS

The FIGURES show the frequency calibration of the device with the unit measurements of all the parts of the Tuning Fork.

### DETAILED DESCRIPTION OF THE DRAWINGS

In the present disclosure, numerous specific details are provided, such as examples and method, to provide a thorough understanding of embodiments of the invention. Persons of ordinary skill in the art will recognize, however, that the invention can be practiced without one or more of the specific details. In other instances, well-known details are not shown.

Tuning Forks with a pointed stem deliver sound and vibration with a point to the precise area of discomfort; thus creating a relaxation of muscle tissue. Bodies respond to sound as well as vibration, even more so with a precise directional approach in a ⅛th inch pointed device. It is a non-needle like instrument or probe that does not penetrate the skin. The invention claimed here solves this problem. This set is made with the following frequencies of 108.0 Hz, 111.0 Hz, 114.42 Hz, 121.23 Hz, 128.43 Hz, 136.07 Hz, 144.16 Hz, 80.91 Hz, 42.86 Hz. Alternate and custom sets can be made with various frequencies employing the pointed stem, specialty design of weights, anodization and advanced grade of aluminum alloy. (FIGURE)

The version of the invention includes: Obtaining 6160 Aluminum alloy and make a mold to create the smooth weights, pointed stems and tines portions of the tuning forks. This is created with a CNC & Turning machine and when completed—anodize the surface and last tuned to the correct frequency within 0.1-0.5 Hz. This product needs the expertise of someone who understands how a tuning fork operates and how to use it which influences the tuning and design. This product also requires the expertise of someone in the manufacturing of a medical/aerospace equipment to determine how to make a mold, use the proper equipment such as a CNC & turning machine, to complete the process using the various tools of manufacturing metals to create a uniform finished product from a specific design that is unique to this device. This is a device that is easy to clean for the practitioner to use and able to clean between clients. It offers a directional point that has not been offered before with a tuning fork. This device will also be offered with complete instructions on how use it to benefit a client during treatment. Proper use of the equipment is rare to find at this time as most simply provide the tuning forks without or with minimal instruction.

While specific embodiments of the present invention have been provided, it is to be understood that these embodiments are for illustration purposes and not limiting. Many additional embodiments will be apparent to persons of ordinary skill in the art reading this disclosure.

What is claimed for is:

1. A tuning fork with a pointed stem;

2. The stem as described in claim 1 is pointed with ⅛th inch pointed device and of ¼th inch diameter;

3. The Tuning fork as described in claim 1 is obtained by making use of 6160 Aluminum alloy which is molded to create weights, pointed stems and tines portions of the tuning fork;

4. The mold as described in claim 3 is created with CNC and Turning Machine and on completion the surface-engraved is anodized and lastly turned to the correct frequency of the range 0.1-0.5 Hz.

5. The Tuning Fork as described in claim 1 has a directional point and is made up of the following frequencies of 108.0 Hz, 111.0 Hz, 114.42 Hz, 121.23 Hz, 128.43 Hz, 136.07 Hz, 144.16 Hz, 80.91 Hz, 42.86 Hz.
